(19) United States
(12) Patent Application Publication
(10) Pub. No.: US 2022/0351612 A1
(43) Pub. Date: Nov. 3, 2022

(54) CONTROL APPARATUS, MOBILE OBJECT, MANAGEMENT SERVER, BASE STATION, COMMUNICATION SYSTEM, AND COMMUNICATION METHOD

(71) Applicant: Mitsubishi Electric Corporation, Tokyo (JP)

(72) Inventors: Takashi ASAHARA, Tokyo (JP); Yasushi MATSUTAKA, Tokyo (JP); Toshinori HORI, Tokyo (JP); Koshiro ISHIHARA, Tokyo (JP); Yasunori KATO, Tokyo (JP); Shusaku UMEDA, Tokyo (JP); Kenichi NAKURA, Tokyo (JP)

(73) Assignee: Mitsubishi Electric Corporation, Tokyo (JP)

(21) Appl. No.: 17/868,397

(22) Filed: Jul. 19, 2022

Related U.S. Application Data
(63) Continuation of application No. PCT/JP2020/002610, filed on Jan. 24, 2020.

(51) Int. Cl. G08G 1/015; G08G 1/00

(52) U.S. Cl. CPC G08G 1/015; G08G 1/22

(57) ABSTRACT

A control apparatus (10) generates probe data from sensing data obtained by sensing objects in a mobile object's surroundings. The control apparatus (10) selects at least some pieces of probe data as transmission data from the probe data generated, according to a communication resource determined according to a role of the mobile object. The control apparatus (10) transmits the transmission data selected to a management server (20). The management server (20) updates management data such as a dynamic map based on the transmission data.

### CROSS REFERENCE TO RELATED APPLICATIONS

This application is a Bypass Continuation of PCT International Application No. PCT/JP2020/002610 filed on Jan. 24, 2020, which is hereby expressly incorporated by reference, in its entirety, into the present application.

### TECHNICAL FIELD

The present disclosure relates to at least one of technology to deliver data such as a dynamic map and the like to a control apparatus installed on a mobile object such as a vehicle and the like, and technology to collect from a control apparatus installed on a mobile object, data necessary for generating data such as a dynamic map and the like.

### BACKGROUND ART

An automated driving system utilizing a dynamic map is being considered. A dynamic map is a high-precision three-dimensional map generated by information of a sensor and the like arranged on a vehicle, a roadside, and the like being collected, and is a high-precision three-dimensional map to which information that changes in terms of time is added. By utilizing the dynamic map, control using not only information in a sensing range of a sensor installed on a vehicle but also information in a sensing range of a sensor installed on a different vehicle and the like is possible to be performed.

Utilizing MEC (Multi-access Edge Computing) as a method to provide a dynamic map to a vehicle that is traveling is being considered. MEC is a system that is being standardized at ETSI (European Telecommunications Standards Institute).

In a case where edge computing is to be used as with MEC, a process such as the following is realized.

Sensing data is obtained by various types of sensors and the like installed on a vehicle. The sensing data is collected in an edge computer with higher processing capability than an in-vehicle device through a base station (gNB) using cellular communication technology such as fifth generation mobile communication system and the like. The edge computer updates the dynamic map in real time using the data collected, and delivers the data of the dynamic map that is updated to each vehicle.

In a case where edge computing is to be used, management servers, MEC servers, are positioned dispersedly around a base station in a cellular network, the cellular network being configured of a terminal, the base station, and a core network. And, the management servers that are positioned dispersedly provide a dynamic map of a narrow area to a vehicle traveling in a cell of a base station connected to a management server.

By the above, for example, a transfer delay and a network load due to communication between the management server in a cloud that provides a wider dynamic map and the vehicle are expected to be reduced. Depending on a distribution situation of vehicles in a cell, however, when many vehicles that are traveling in a same cell perform communication with the management server simultaneously, there is a possibility of the network load becoming heavy locally because of increased traffic. As a result, congestion in the network and a communication delay occur. And, there is a possibility of a problem developing such as a communication error occurring in the communication between the vehicle and the management server.

Because of the above, ranking collection accuracy of surrounding information of each vehicle based on information on a type and performance of a sensor installed on each vehicle, and collecting information preferentially from a vehicle with high collection accuracy are being considered (refer to Patent Literature 1). By the above, reducing a communication amount in an upstream direction, the upstream direction being in a direction of the management server from the vehicle, is being attempted.

### CITATION LIST

### Patent Literature

Patent Literature 1: JP 2017-194915 A

### SUMMARY OF INVENTION

### Technical Problem

Sensors to be installed on a vehicle have been increasing in number for the purpose of improving safety of the vehicle and realization of automated driving. A high definition camera and the like are starting to be installed as a sensor. Consequently, data collected from each vehicle is increasing, and selecting useful data for generation of a dynamic map and the like is necessary to reduce a network load in communication in an upstream direction.

In a system that collects information preferentially from a vehicle with high collection accuracy as with a conventional system, however, it is necessary for a type and performance of a sensor installed on each vehicle to be obtained in advance and managed by a database. This database can only be built by a company and the like that manufactures vehicles.

When the network load becomes high, there is a possibility where necessary data cannot be transmitted to each vehicle at a timing that is appropriate in communication in a downstream direction, the downstream direction being in a direction of each vehicle from a management server such as an edge computer and the like.

The present disclosure aims to realize efficient communication between each mobile object and a management server.

### Solution to Problem

A control apparatus according to the present disclosure is a control apparatus to be installed on a mobile object. The control apparatus includes:

a probe data generation unit to generate probe data from sensing data obtained by sensing objects in the mobile object's surroundings;

a transmission data selection unit to select at least some pieces of probe data as transmission data from the probe data generated by the probe data generation unit, according to a communication resource determined according to a role of the mobile object; and

a data transmission unit to transmit the transmission data selected by the transmission data selection unit to a management server that manages management data.

### Advantageous Effects of Invention

In the present disclosure, at least some pieces of probe data are selected as transmission data according to a communication resource determined according to a role of a target object on which a control apparatus is installed. By the above, data in an appropriate data amount can be collected from the target object. As a result, collecting of data efficiently will be possible.

### BRIEF DESCRIPTION OF DRAWINGS

FIG. 1 is a configuration diagram of a communication system 1 according to Embodiment 1.

FIG. 2 is a functional configuration diagram of a control apparatus 10 according to Embodiment 1.

FIG. 3 is a hardware configuration diagram of the control apparatus 10 according to Embodiment 1.

FIG. 4 is a functional configuration diagram of a management server 20 according to Embodiment 1.

FIG. 5 is a hardware configuration diagram of the management server 20 according to Embodiment 1.

FIG. 6 is a functional configuration diagram of a base station 30 according to Embodiment 1.

FIG. 7 is a hardware configuration diagram of the base station 30 according to Embodiment 1.

FIG. 8 is a process flow of processes up until a start of data communication in the communication system 1 according to Embodiment 1.

FIG. 9 is a process flow of a process in a case where an allocation of a resource cannot be done in the communication system 1 according to Embodiment 1.

FIG. 10 is a process flow of a data communication process in an upstream direction in the communication system 1 according to Embodiment 1.

FIG. 11 is a process flow of a data communication process in a downstream direction in the communication system 1 according to Embodiment 1.

FIG. 12 is a diagram illustrating specific examples of roles of a vehicle 100 according to Embodiment 1.

FIG. 13 is a process flow of a resource allocation changing process according to Embodiment 2.

FIG. 14 is a process flow of processes up until a start of data communication in a communication system 1 according to Embodiment 3.

FIG. 15 is a functional configuration diagram of a base station 30 according to Embodiment 4.

FIG. 16 is a process flow of processes up until a start of data communication in a communication system 1 according to Embodiment 4.

### DESCRIPTION OF EMBODIMENTS

### Embodiment 1

***Description of Configuration***

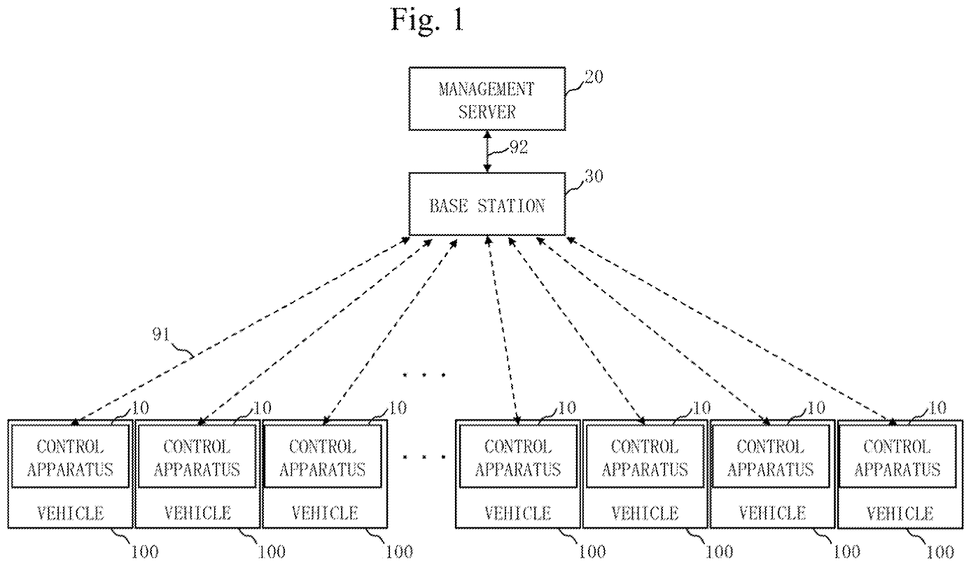

A configuration of a communication system 1 according to Embodiment 1 will be described by referring to FIG. 1.

The communication system 1 includes one or more control apparatuses 10, a management server 20, and a base station 30.

The control apparatus 10 is connected to the base station 30 by a wireless network 91. The management server 20 is connected to the base station 30 by a wired network 92.

The control apparatus 10 is a computer installed on a vehicle 100 that is a mobile object. In Embodiment 1, the mobile object will be described as being the vehicle 100. The mobile object, however, may be a boat, a pedestrian, and the like, not limited to the vehicle 100. In Embodiment 1, it is assumed that the vehicle 100 is a four-wheeled vehicle. The vehicle 100, however, may be a two-wheeled vehicle such as a motorcycle and a bicycle. The control apparatus 10 transmits sensing data obtained by a sensor installed on the vehicle 100 to the management server 20 through the base station 30 according to a role of the vehicle 100.

The management server 20 is a computer that manages a dynamic map. The management server 20 updates the dynamic map by sensing data collected from the control apparatus 10. The management server 20 delivers, among management data that are data of the dynamic map that have been updated, management data according to the role of the vehicle 100 to the control apparatus 10.

The base station 30 is a base station in cellular communication technology, and relays communication between the control apparatus 10 and the management server 20.

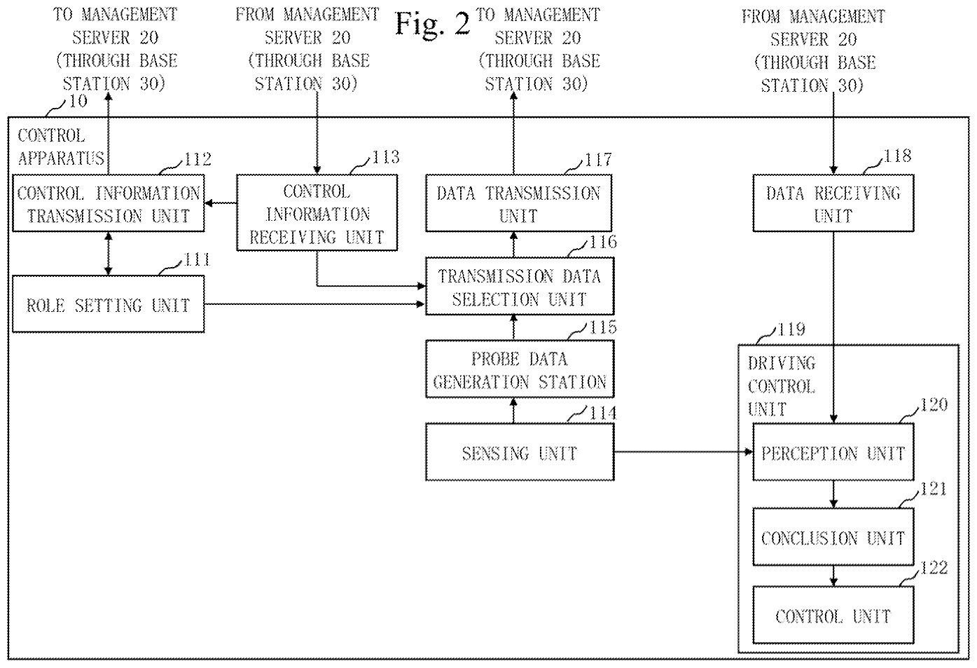

A functional configuration of the control apparatus 10 according to Embodiment 1 will be described by referring to FIG. 2.

The control apparatus 10 includes, as functional components, a role setting unit 111, a control information transmission unit 112, a control information receiving unit 113, a sensing unit 114, a probe data generation unit 115, a transmission data selection unit 116, a data transmission unit 117, a data receiving unit 118, and a driving control unit 119. The driving control unit 119 includes a perception unit 120, a conclusion unit 121, and a control unit 122.

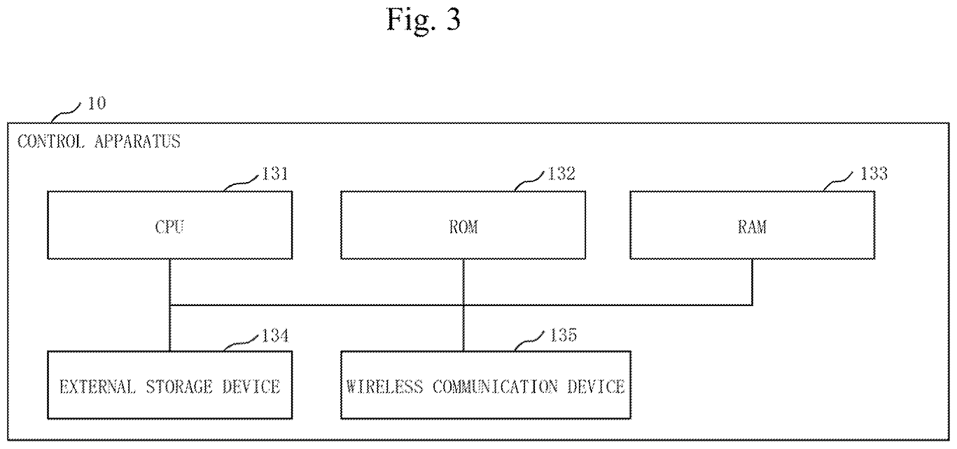

A hardware configuration of the control apparatus 10 according to Embodiment 1 will be described by referring to FIG. 3.

The control apparatus 10 includes a CPU 131 (Central Processing Unit), a ROM 132 (Read Only Memory), a RAM 133 (Random Access Memory), an external storage device 134, and a wireless communication device 135. As a specific example, the external storage device 134 is a hard disk drive. The wireless communication device 135 is an interface of the wireless network 91. The wireless communication device 135 is able to perform transmission of data to/receiving of data from the base station 30.

A program that realizes each functional component of the control apparatus 10 is stored in one of the ROM 132, the RAM 133, and the external storage device 134. This program is read into and executed by the CPU 131. By the above, functions of each functional component of the control apparatus 10 are realized.

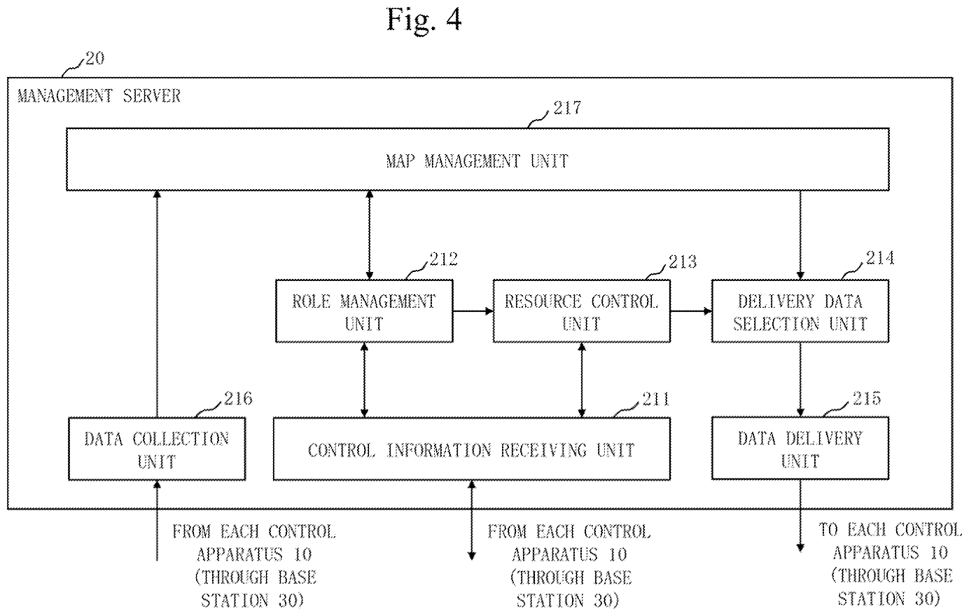

A functional configuration of the management server 20 according to Embodiment 1 will be described by referring to FIG. 4.

The management server 20 includes, as functional components, a control information receiving unit 211, a role management unit 212, a resource control unit 213, a delivery data selection unit 214, a data delivery unit 215, a data collection unit 216, and a map management unit 217.

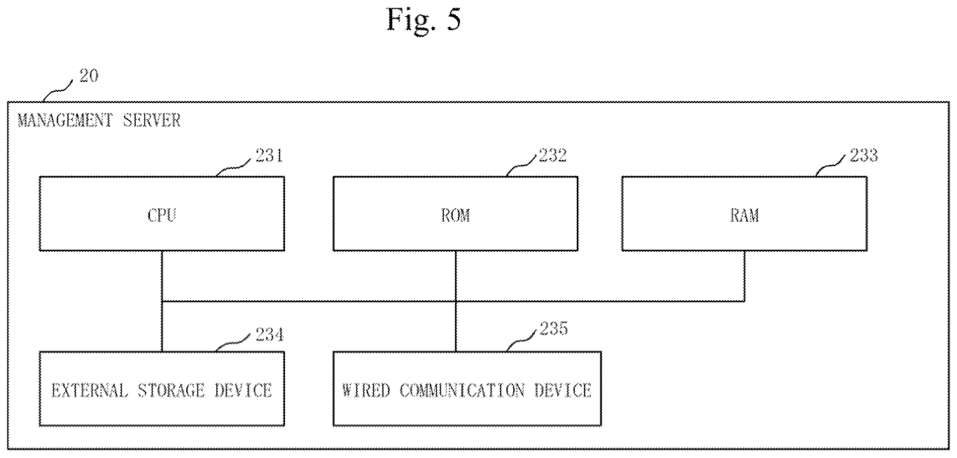

A hardware configuration of the management server 20 according to Embodiment 1 will be described by referring to FIG. 5.

The management server 20 includes a CPU 231, a ROM 232, a RAM 233, an external storage device 234, and a wired communication device 235. As a specific example, the external storage device 234 is a hard disk drive. The wired communication device 235 is an interface of the wired network 92. The wired communication device 235 is able to perform transmission of data to/receiving of data from the base station 30.

A program that realizes each functional component of the management server 20 is stored in one of the ROM 232, the RAM 233, and the external storage device 234. This program is read into and executed by the CPU 231. By the above, functions of each functional component of the management server 20 are realized.

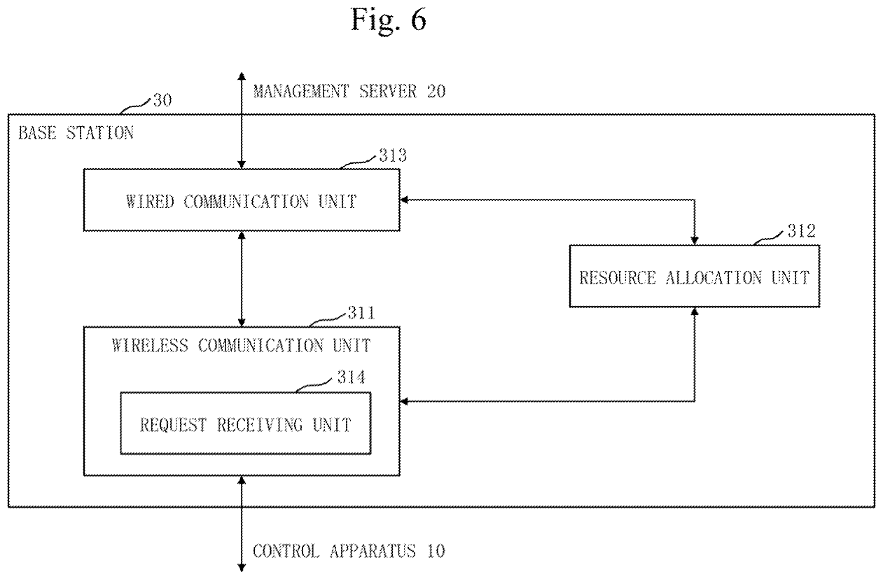

A functional configuration of the base station 30 according to Embodiment 1 will be described by referring to FIG. 6.

The base station 30 includes, as functional components, a wireless communication unit 311, a resource allocation unit 312, and a wired communication unit 313. The wireless communication unit 311 includes a request receiving unit 314.

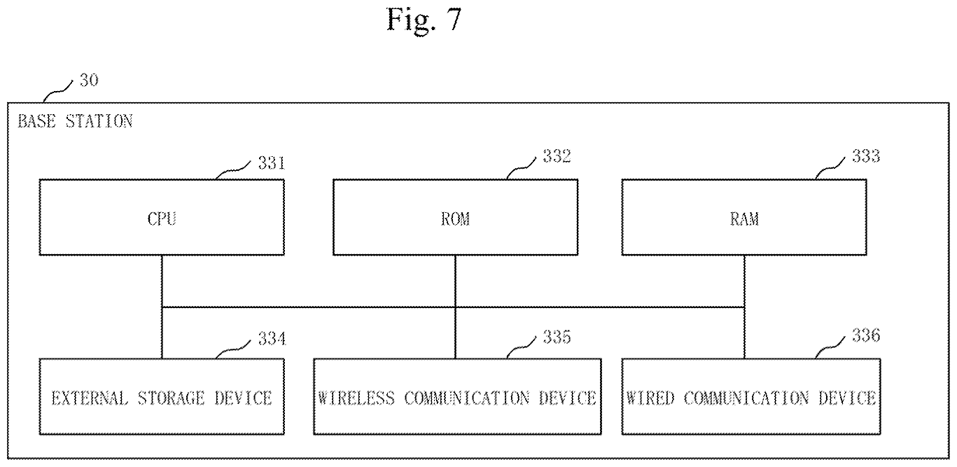

A hardware configuration of the base station 30 according to Embodiment 1 will be described by referring to FIG. 7.

The base station 30 includes a CPU 331, a ROM 332, a RAM 333, an external storage device 334, a wireless communication device 335, and a wired communication device 336. As a specific example, the external storage device 334 is a hard disk drive. The wireless communication device 335 is an interface of the wireless network 91. The wireless communication device 335 is able to perform transmission of data to/receiving of data from the control apparatus 10. The wired communication device 336 is an interface of the wired network 92. The wired communication device 336 is able to perform transmission of data to/receiving of data from the management server 20.

A program that realizes each functional component of the base station 30 is stored in one of the ROM 332, the RAM 333, and the external storage device 334. This program is read into and executed by the CPU 331. By the above, functions of each functional component of the base station 30 are realized.

The CPU 131, 231, and 331 may be replaced by one or more processors such as an ASIC (Application Specific Integrated Circuit), an FPGA (Field Programmable Gate Array), and a DSP (Digital Signal Processor).

***Description of Operation***

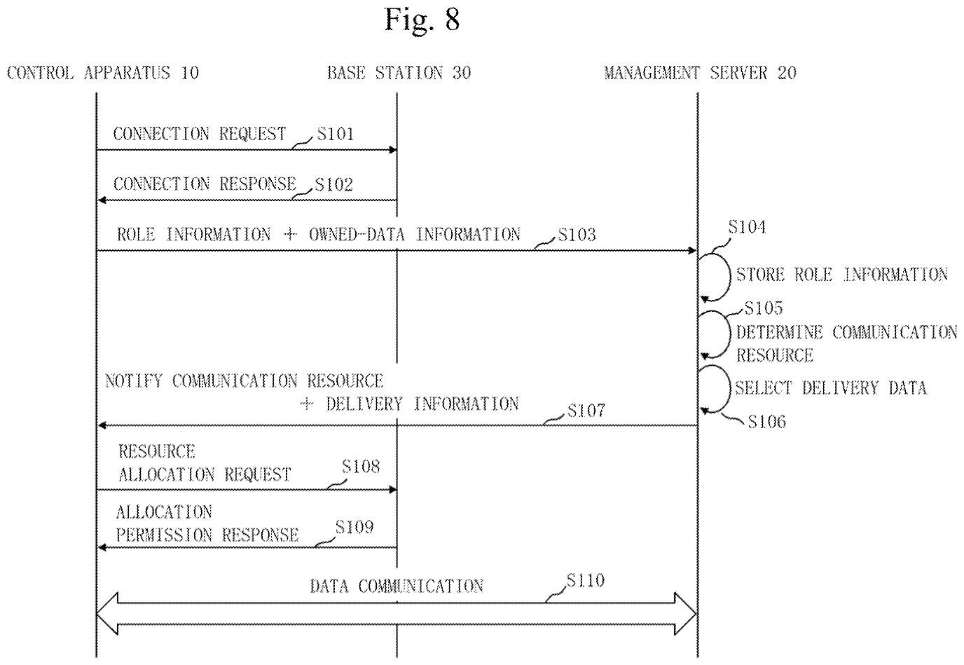

Operation of the communication system 1 according to Embodiment 1 will be described by referring to FIG. 8 to FIG. 12.

An operation procedure of the communication system 1 according to Embodiment 1 is equivalent to a communication method according to Embodiment 1. A program that realizes the operation of the communication system 1 according to Embodiment 1 is equivalent to a communication program according to Embodiment 1.

Processes up until a start of data communication in the communication system 1 according to Embodiment 1 will be described by referring to FIG. 8.

For advance preparation, the role setting unit 111 of the control apparatus 10 sets a role of a target object that is the vehicle 100 on which the control apparatus 10 is installed. Specifically, the role setting unit 111 accepts role information that indicates a role inputted by a manager and the like of the control apparatus 10, and writes the role information that has been accepted into the external storage device 134. The role setting unit 111 may accept role information inputted by an input device connected to the control apparatus 10 being operated, or may accept role information inputted by a terminal connected by the wireless network 91 and the like being operated.

There is also a case where a role is determined based on a relationship between the target object and a different vehicle 100. In this case, the role setting unit 111 sets, based on a result of communication with a different vehicle 100 through the base station 30, or on a result of communication with a different vehicle 100 by vehicle-to-vehicle communication, the role of the target object.

In step S101, the control information transmission unit 112 of the control apparatus 10 transmits a connection request to the base station 30. In step S102, the wireless communication unit 311 of the base station 30 receives the connection request transmitted in step S101, and transmits to the control apparatus 10, a connection response that permits connection.

In step S103, the control information receiving unit 113 of the control apparatus 10 receives the connection response transmitted in step S102. Then, the control information transmission unit 112 of the control apparatus 10 reads the role information that indicates the role of the target object from the external storage device 134. The control information transmission unit 112 transmits the role information and owned-data information that indicates a type of data and the like obtained by the sensing unit 114 to the base station 30. The wireless communication unit 311 of the base station 30 receives the role information and the owned-data information. The wired communication unit 313 of the base station 30 transmits the role information and the owned-data information to the management server 20.

In step S104, the control information receiving unit 211 of the management server 20 receives the role information and the owned-data information transmitted in step S103. Then, the role management unit 212 of the management server 20 stores the role information. Role information on a plurality of vehicles 100 will be stored in the role management unit 212.

In step S105, the resource control unit 213 of the management server 20 determines a communication resource with regard to the control apparatus 10 installed on the target object according to the role that the role information on the target object indicates. At this time, the resource control unit 213 may determine the communication resource with regard to the control apparatus 10 installed on the target object by referring to the role information on a different vehicle 100 stored by the role management unit 212. In step S106, the delivery data selection unit 214 of the management server 20 selects at least some pieces of management data among the management data as delivery data according to the communication resource determined in step S105. In Embodiment 1, the management data is the data of the dynamic map.

In step S107, the data delivery unit 215 of the management server 20 transmits to the base station 30, the communication resource and delivery information that indicates information included in the delivery data. The wired communication unit 313 of the base station 30 receives the communication resource and the delivery information. The wireless communication unit 311 of the base station 30 transmits the communication resource and the delivery information to the control apparatus 10.

In step S108, the control information receiving unit 113 of the control apparatus 10 receives the communication resource and the delivery information transmitted in step S107. The control information transmission unit 112 of the control apparatus 10 transmits an allocation request of a resource indicating the communication resource to the base station 30. In step S109, the wireless communication unit 311 (request receiving unit 314) of the base station 30 receives the allocation request of the resource transmitted in step S108. Then, the resource allocation unit 312 of the base station 30 allocates the communication resource that the allocation request indicates to the control apparatus 10 installed on the target object. And then, the wireless communication unit 311 of the base station 30 transmits to the control apparatus 10, an allocation permission response that indicates that the resource is allocated.

In step S110, the control information receiving unit 113 of the control apparatus 10 receives the allocation permission response. And then, the control apparatus 10 carries out data communication with the management server 20 using the communication resource that has been allocated.

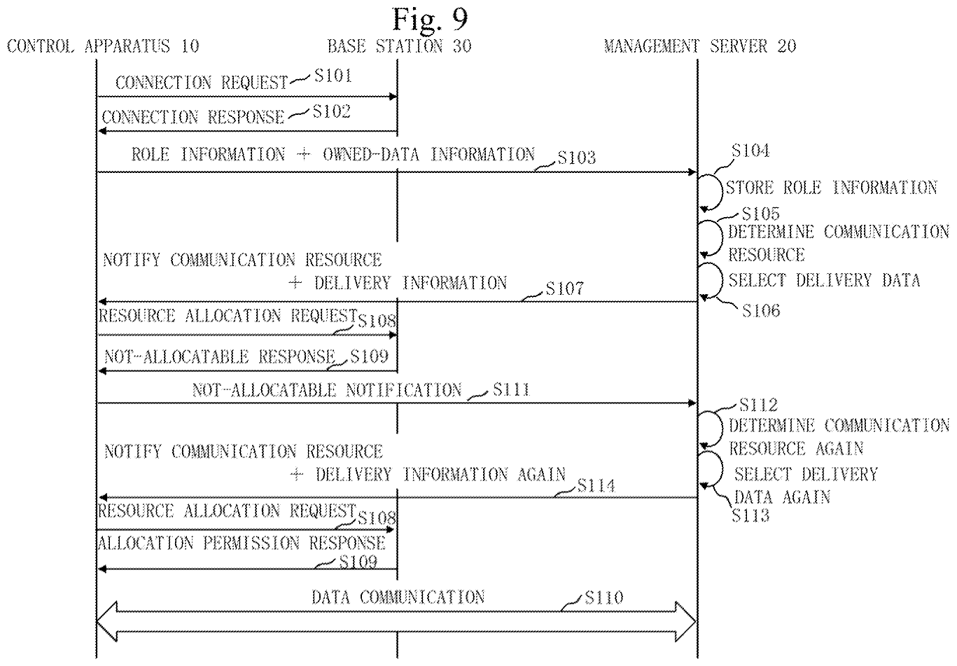

A process in a case where allocating a resource in the communication system 1 according to Embodiment 1 cannot be done will be described by referring to FIG. 9.

There is a possibility that the communication resource that the allocation request indicates cannot be allocated by the base station 30. For example, in a case where many vehicles 100 exist in a cell of the base station 30, there is a possibility of open resources not being enough and the communication resource that the allocation request indicates cannot be allocated.

In this case, in step S109, the wireless communication unit 311 of the base station 30 transmits to the control apparatus 10, a not-allocatable response that indicates that the resource could not be allocated.

In step S111, the control information receiving unit 113 of the control apparatus 10 receives the not-allocatable response. Then, the control information transmission unit 112 of the control apparatus 10 transmits to the base station 30, a not-allocatable notification that indicates that the resource could not be allocated. The wireless communication unit 311 of the base station 30 receives the not-allocatable notification. The wired communication unit 313 of the base station 30 transmits the not-allocatable notification to the management server 20.

In step S112, the control information receiving unit 211 of the management server 20 receives the not-allocatable notification transmitted in step S111. Then, the resource control unit 213 of the management server 20 determines again the communication resource with regard to the control apparatus 10 installed on the target object by referring to the communication resource determined last time. For example, the resource control unit 213 sets the communication resource less than the communication resource determined the last time. In step S113, the delivery data selection unit 214 of the management server 20 selects again at least some pieces of management data among the management data as the delivery data according to the communication resource determined again in step S112.

In step S114, the data delivery unit 215 of the management server 20 transmits to the base station 30, the communication resource and the delivery information indicating the information included in the delivery data. The wired communication unit 313 of the base station 30 receives the communication resource and the delivery information. The wireless communication unit 311 of the base station 30 transmits the communication resource and the delivery information to the control apparatus 10.

And then, processes that are processes from step S108 to step S109 are executed. Processes from step S111 to step S114 and the processes from step S108 to step S109 are repeatedly executed until the allocation permission response is transmitted in step S109. When the allocation permission response is transmitted in step S109, the process of step S110 is executed.

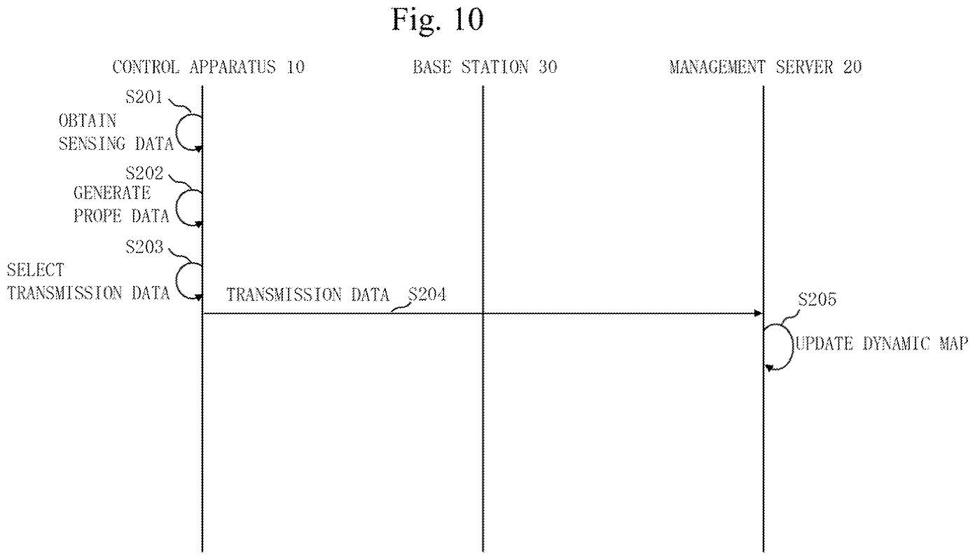

A data communication process in an upstream direction in the communication system 1 according to Embodiment 1 will be described by referring to FIG. 10.

The data communication process is the process of step S110 in FIG. 8 or FIG. 9. The data communication process in the upstream direction is a data communication process in a direction of the management server 20 from the control apparatus 10.

The process illustrated in FIG. 10 is executed periodically or with some event being a trigger. In a case where the process illustrated in FIG. 10 is to be executed periodically, the transmission data selection unit 116 of the control apparatus 10 may determine intervals in which the process is executed according to the communication resource allocated.

In step S201, the sensing unit 114 of the control apparatus 10 obtains sensing data obtained by sensing with regard to the target object, and sensing data obtained by sensing objects in the target object's surroundings.

As specific examples, the sensing data is position information of the target object, movement information that indicates speed and acceleration of the target object, and surrounding information such as a position and size of an object in the target object's surroundings. The position information of the target object is specified by a positioning signal obtained by a GPS (Global Positioning System) antenna installed on the target object. The movement information of the target object is obtained by a speed sensor and an acceleration sensor installed on the target object. The surrounding information is collected by a sensor such as a radar, LiDAR, and a camera installed on the target object.

In step S202, the probe data generation unit 115 of the control apparatus 10 generates probe data from the sensing data obtained in step S201.

As specific examples, the probe data is road information such as a traffic light, a road sign, and a road type, traffic information such as a degree of traffic congestion, a windshield wiper operation situation, temperature inside and outside of a vehicle and a road surface, weather, a situation of a road surface, a vehicle type and performance of the target object, the position information of the target object, the speed and the acceleration of the target object, the number of occupants of the target object, the surrounding information itself, and obtained date and time of the surrounding information.

In step S203, the transmission data selection unit 116 of the control apparatus 10 selects at least some pieces of probe data as transmission data from the probe data generated in step S202, according to the communication resource determined according to the role of the target object. That is, the transmission data selection unit 116 selects transmission data according to the communication resource determined by the management server 20 in the processes up until the start of data communication illustrated in FIG. 8.

In step S204, the data transmission unit 117 of the control apparatus 10 transmits the transmission data selected in step S203 to the base station 30. The wireless communication unit 311 of the base station 30 receives the transmission data. The wired communication unit 313 of the base station 30 transmits the transmission data to the management server 20.

In step S205, the data collection unit 216 of the management server 20 receives the transmission data transmitted in step S204. Then, the map management unit 217 of the management server 20 updates the dynamic map based on the transmission data.

The transmission data is transmitted from the control apparatus 10 installed on the plurality of vehicles 100. Consequently, the data collection unit 216 receives many pieces of transmission data. The map management unit 217 updates the dynamic map based on the transmission data transmitted from the control apparatus 10 installed on each vehicle 100. The map management unit 217 may update the dynamic map periodically or with some event being a trigger.

The dynamic map is configured of a static high-precision three-dimensional map and information that changes with time and with which a position specifiable. The static high-precision three-dimensional map is called static information. Semi-static information, semi-dynamic information, and dynamic information are included in the information that changes with time and with which the position is specifiable.

The static information is information such as three-dimensional data that indicates three-dimensional coordinates of an object, road surface information, lane information, and the like, and is updated on a monthly basis. The semi-static information is information such as traffic regulation information, road construction information, wide area weather information, and the like, and is updated on an hourly basis. The semi-dynamic information is information such as accident information, traffic congestion information, narrow area weather information, and the like, and is updated on a minute by minute basis. The dynamic information is information such as surrounding vehicles, pedestrian information, traffic light information, and the like, and is updated on a second by second basis. Update frequency of each piece of information is an example, and there may be a case where update frequency differs from the update frequency mentioned above.

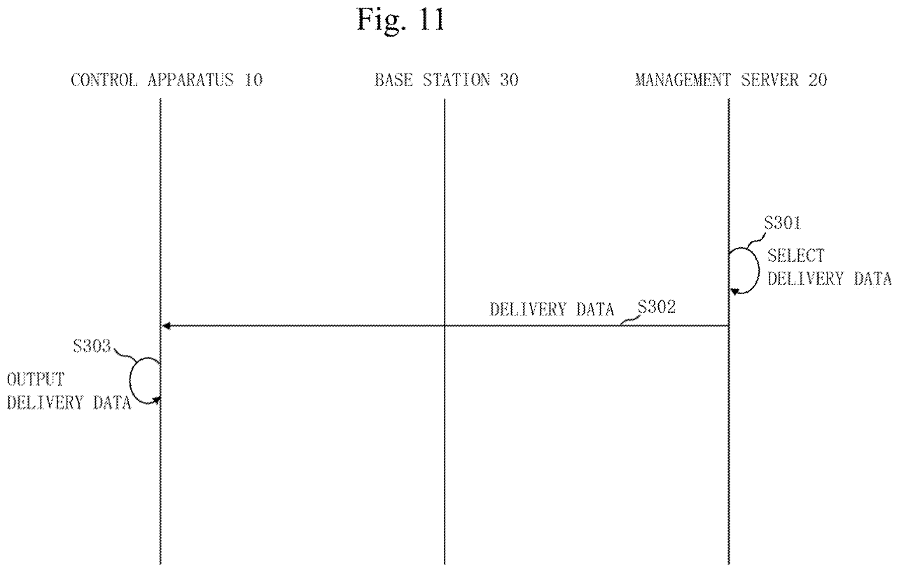

A data communication process in a downstream direction in the communication system 1 according to Embodiment 1 will be described by referring to FIG. 11.

The data communication process is the process of step S110 in FIG. 8 or FIG. 9. The data communication process in the downstream direction is a data communication process in a direction of the control apparatus 10 from the management server 20.

The process illustrated in FIG. 11 is executed periodically or with some event being a trigger. In a case where the process illustrated in FIG. 11 is to be executed periodically, the delivery data selection unit 214 of the management server 20 may determine intervals in which the process is executed according to the communication resource allocated to the control apparatus 10 installed on the target object.

In step S301, the delivery data selection unit 214 of the management server 20 selects at least some pieces of data among the management data as delivery data according to the communication resource allocated to the control apparatus 10 installed on the target object. Here, the management data is the data of the dynamic map. The delivery data selection unit 214 preferentially selects data with a degree of importance that is high in controlling of the target object as the delivery data.

The delivery data selection unit 214 may change the data to be selected as the delivery data every time the process of FIG. 11 is executed. As a specific example, the delivery data selection unit 214 selects only data with the degree of importance that is high as the delivery data as a general rule, and only once every few times selects data with the degree of importance that is medium in addition to the data with the degree of importance that is high as the delivery data. For example, with regard to the semi-static information, the semi-dynamic information, and the dynamic information, the degree of importance is high in realizing automated driving. Consequently, it is preferable that these pieces of information are delivered to each vehicle 100 at comparatively short time intervals during when the vehicle 100 is traveling. Therefore, a case may be considered where the delivery data selection unit 214 selecting a part of data of these pieces of information as the delivery data every time the process of FIG. 11 is executed with regard to the part of data of these pieces of information, and selecting the static information as the delivery data only once every few times with regard to the static information.

In step S302, the data delivery unit 215 of the management server 20 transmits the delivery data selected in step S301 to the base station 30. The wired communication unit 313 of the base station 30 receives the delivery data. The wireless communication unit 311 of the base station 30 transmits the delivery data to the control apparatus 10.

The data delivery unit 215 may deliver the static information, the semi-static information, the semi-dynamic information, and dynamic information individually to the target object, or may deliver every piece of data all at once to the target object.

In step S303, the data receiving unit 118 of the control apparatus 10 receives the delivery data transmitted in step S302. The data receiving unit 118 outputs the delivery data to the driving control unit 119. Then, the driving control unit 119 of the control apparatus 10 performs driving control of the target object taking the delivery data into consideration.

A process of the driving control unit 119 of the control apparatus 10 will be described.

The driving control of the target object is performed in the driving control unit 119 by perceiving a traveling situation of the target object and a surrounding situation of the target object based on the sensing data obtained by the sensing unit 114 and the delivery data that is the data of the dynamic map.

Specifically, the perception unit 120 perceives the traveling situation of the target object from the sensing data. The traveling situation of the target object is position, speed, acceleration, and the like of the target object. The perception unit 120 perceives the surrounding situation of the target object from the sensing data and the delivery data. The surrounding situation of the target object is information on obstacles that exist in the target object's surroundings, information on objects such as a different vehicle 100 and a pedestrian, information on traffic lights and signs, information on driving lanes, and the like. The conclusion unit 121 determines a travel route of the target object based on information perceived by the perception unit 120 and a safety restriction. And then, the control unit 122 controls actuators such as brakes, an accelerator, a steering wheel, and the like of the target object in a way that the target object will travel on the travel route determined by the conclusion unit 121.

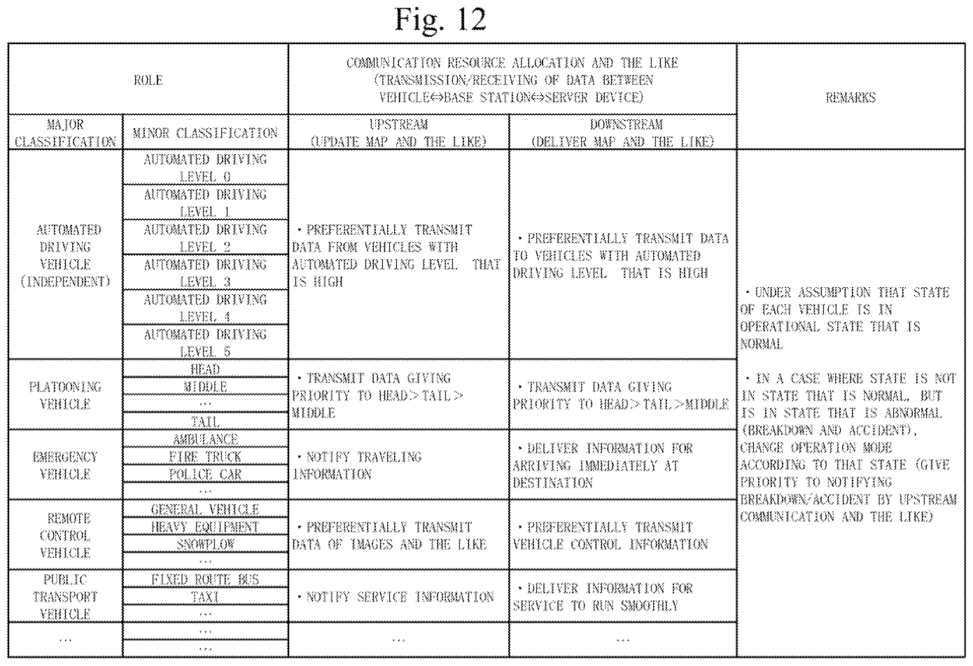

Specific examples of roles of the vehicle 100 according to Embodiment 1 will be described by referring to FIG. 12.

The roles are divided into major classifications, and are further divided into minor classifications for every major classification. The communication resource is determined according to a combination of a major classification and a minor classification.

As major classifications, there are classifications such as an automated driving vehicle (independent), a platooning vehicle, an emergency vehicle, a remote control vehicle, and a public transport vehicle. An automated driving vehicle (independent) is the vehicle 100 that performs automated driving control independently. A platooning vehicle is the vehicle 100 that performs automated driving control by forming a platoon with the plurality of vehicles 100. An emergency vehicle is the vehicle 100 with high urgency such as an ambulance. A remote control vehicle is the vehicle 100 that is remotely operated. A public transport vehicle is the vehicle 100 of public transportation such as a fixed route bus.

In a case where the major classification is automated driving vehicle (independent), the minor classifications are automated driving levels. The automated driving levels are defined by SAE (Society of Automotive Engineer) United States of America.

According to SAE, levels of automated driving are classified from 0 to 5, and automation level of driving operation becomes higher as a numerical value becomes larger. Specifically, automated driving level 0 is “no driving automation” where a driver executes all of dynamic driving tasks. Automated driving level 1 is “driving support” where a system executes in a limited way, a task of vehicle driving control relating to either forward and backward or left and right. Automated driving level 2 is “partial driving automation” where a system executes in a limited way, a task of vehicle driving control relating to both forward and backward and left and right. Automated driving level 3 is “conditional driving automation” where a system executes in a limited way, all of the dynamic driving tasks, but in a case where continuation of work is difficult, a driver will respond to and handle an intervention request and the like of the system. Automated driving level 4 is “high driving automation” where a system executes all of the dynamic driving tasks and executes a response in a limited way to a case where continuation of work is difficult. Automated driving level 5 is “full driving automation” where a system executes all of the dynamic driving tasks and executes a response in an unlimited way to a case where continuation of work is difficult. Those that are called automated driving are levels 3 to 5.

As described, the vehicle 100 with an automated driving level that is high is considered to be collecting more highly accurate information necessary for traveling compared with the vehicle 100 with an automated driving level that is low. Consequently, in a case where the management server 20 is to collect information from the control apparatus 10 installed on each vehicle 100, performing collection of data by allocating more communication resources to the vehicle 100 with an automated driving level that is high is preferable.

On the other hand, information necessary for traveling for the vehicle 100 with an automated driving level that is low is considered as being less compared with information necessary for traveling for the vehicle 100 with an automated driving level that is high. Consequently, in a case where information is to be delivered from the management server 20 to each vehicle 100, performing delivery of information such as the dynamic map and the like by allocating more communication resources to the vehicle 100 with an automated driving level that is high is preferable.

In the vehicle 100 with an automated driving level that is high, a task of driving operation by an occupant will be reduced. Consequently, allocating communication resources not only of information necessary for controlling automated driving and the like but also of information on entertainment and the like to the occupant of the vehicle 100 with an automated driving level that is high can be considered.

In a case where the major classification is “platooning vehicle”, the minor classifications are positions of the vehicles 100 in a platoon.

For example, the minor classifications of the role of the vehicle 100 in the platooning vehicles being head, tail, and middle that is sandwiched between the head and the tail can be considered. In this case, the vehicle 100 at the head that leads the platoon has a large amount of information for traveling, or is assumed as necessitating a large amount of information for traveling. The vehicle 100 at the tail coming after the head is assumed as necessitating not only following a vehicle in front but also monitoring the vehicle 100 in the middle of the platoon, monitoring a vehicle 100 behind that is not a platooning vehicle, and the like. Consequently, allocation of the communication resource in data communication in an upstream direction and in data communication in a downstream direction are necessary to be performed in an order of priority, from the head, the tail, and then the middle.

At a time of forming a platoon, a role according to a position in the platoon is set to each vehicle 100 by inter-vehicle communication through the base station 30, vehicle-to-vehicle communication that does not go through the base station 30, or the like. In a case where there is one of a change in an order in the platoon, a new entry into the platoon, and leaving from the platoon, the role in the platoon is changed by communication between the vehicles 100 every time, and a role after the change is notified to the management server 20.

In a case where the major classification is “emergency vehicle”, the minor classifications are degrees of urgency of a vehicle. As examples of the emergency vehicle, an ambulance, a fire truck, a police car, and the like can be considered. In FIG. 12, the minor classifications are types of emergency vehicles assuming that the degrees of urgency will be decided on for each type of emergency vehicle.

In a case of an emergency vehicle, arriving immediately at a destination will be the most important mission. Consequently, transmitting to the management server 20, information on a position where the emergency vehicle is traveling and the like, and delivering to the vehicle 100, such information as a traffic situation and a route to the destination in a way that the emergency vehicle can immediately arrive at the destination are necessary to be performed preferentially. In a case where a patient and the like have been made to ride on the emergency vehicle, transmission/receiving of information on occupants such as the patient and the like are necessary to be performed preferentially.

In a case where the major classification is “remote control vehicle”, the minor classifications are types of remote control vehicles. The remote control vehicle is a vehicle that is steered by remote operation through a network. A general vehicle, a heavy equipment, a snowplow, and the like can be considered as examples of the remote control vehicle.

In a case of the remote control vehicle, a camera image and the like of remote control vehicle's surroundings photographed by the remote control vehicle are collected, and the remote control vehicle is steered by remote operation while monitoring information of the camera image and the like. Consequently, transmission of image information is necessary to be performed preferentially in a way that the image information can be collected from the vehicle 100 in real time. As for information for the vehicle 100, transmission of vehicle control information such as acceleration and constant-traveling operation by an accelerator, decelerating and stopping operation by brakes, steering operation by a steering wheel, and the like of the vehicle 100 are necessary to be performed preferentially.

In a case where the major classification is “public transport vehicle”, the minor classifications are types of public transport vehicles. A fixed route bus, a taxi, and the like can be considered as public transport vehicles. Along with collecting service information from the vehicle 100 in a way that the public transport vehicle can run smoothly, delivering information on traffic situation and the like in a way that the public transport vehicle can run smoothly on time and the like are necessary to be performed preferentially.

The role information of and the allocation of the communication resource to the vehicle 100 illustrated in FIG. 12 are only examples. In a case where there is a role where preferable allocation of the communication resource differs from allocation of the communication resource to a different vehicle 100, allocation of the communication resource may be performed by providing a new major classification or a minor classification.

### Effect of Embodiment 1

As described above, the communication system 1 according to Embodiment 1 determines a communication resource according to the role of the vehicle 100 and selects data to be transmitted/received according to the communication resource. By the above, performing collection of data necessary for updating the dynamic map and delivery of data of the dynamic map and the like efficiently will be possible.

***Other Configurations***

<Variation 1>

Only one base station 30 was illustrated in FIG. 1. The communication system 1, however, may include a plurality of base stations 30.

<Variation 2>

In Embodiment 1, the management server 20 and the base station 30 were referred to as separate devices. The management server 20 and the base station 30, however, may be configured as one device. In this case, securing an arrangement location of the management server 20 separately from the base station 30 is not necessary. Since it is not necessary for the management server 20 and the base station 30 to communicate through a network, a transfer delay will be short.

<Variation 3>

In Embodiment 1, it was assumed that the communication between the control apparatus 10 and the base station 30 is to be performed by the wireless communication device 135 installed on the control apparatus 10. The communication between the control apparatus 10 and the base station 30, however, may be performed through a smartphone and the like that an occupant of the vehicle 100 owns.

<Variation 4>

In Embodiment 1, the control apparatus 10 is installed on the vehicle 100. The control apparatus 10, however, may be a device that is possible to be taken outside of a car.

<Variation 5>

With regard to the control apparatus 10, there is a case where a percentage of the data communication in the upstream direction is higher compared with a percentage of the data communication in the downstream direction. In this case, it can be admitted that a contribution made towards updating the dynamic map is more compared with a contribution made towards use of the dynamic map. Consequently, some kind of a reward being given to this control apparatus 10 can be considered. For example, the higher the percentage of the data communication in the upstream direction, the more rewards being given can be considered.

Conversely, there is a case where the percentage of the data communication in the downstream direction is higher compared with the percentage of the data communication in the upstream direction. In this case, it can be admitted that the contribution made towards the use of the dynamic map is more compared with the contribution made towards updating the dynamic map. Consequently, some kind of a reward being requested to this control apparatus 10 can be considered. For example, the higher the percentage of the data communication in the downstream direction, the more rewards being requested can be considered.

<Variation 6>

In Embodiment 1, each functional component was realized by software. As Variation 6, however, each functional component may be realized by hardware. In this case, for example, the control apparatus 10, the management server 20, and the base station 30 include an ASIC or an FPGA instead of the CPU 131, 231, and 331. And, each functional component is realized by the ASIC or the FPGA.

Some of each functional component may be realized by hardware, and the rest of each functional component may be realized by software.

The CPU 131, 231, and 331, and the ASIC or the FPGA are called processing circuitry. That is, functions of each functional component are realized by the processing circuitry.

### Embodiment 2

Embodiment 2 differs from Embodiment 1 in that the role is specified based on a static role that is specified regardless of a moving state of the mobile object and a dynamic role that changes according to the moving state of the mobile object. In Embodiment 2, this differing point will be described, and description will be omitted for points that are the same.

The static role is the major classifications and the minor classifications described by referring to FIG. 12. Among the major classifications and the minor classifications illustrated in FIG. 12, however, there is a case where a position in a platoon dynamically changes in a case where the major classification is platooning vehicle. In this case, the position of the vehicle 100 in the platoon, the minor classification, is the dynamic role. In a case where a length of a platoon changes, the length of the platoon can also be the dynamic role.

As the dynamic role, other than the position of the vehicle 100 in a platoon, a vehicle traveling situation arising from the traffic situation and whether or not functions of the vehicle 100 are normal are included. The vehicle traveling situation arising from the traffic situation means such cases where traffic congestion is occurring in which vehicles 100 are repeating start and stop, there are many vehicles 100 and the vehicles 100 are traveling at somewhat slow speed, and there are a few vehicles 100 and the vehicles 100 are traveling smoothly. Whether or not the functions of the vehicle 100 are normal is whether or not functions such as the sensor and a device for a control system installed on the vehicle 100 are operating normally and whether or not an abnormality is occurring.

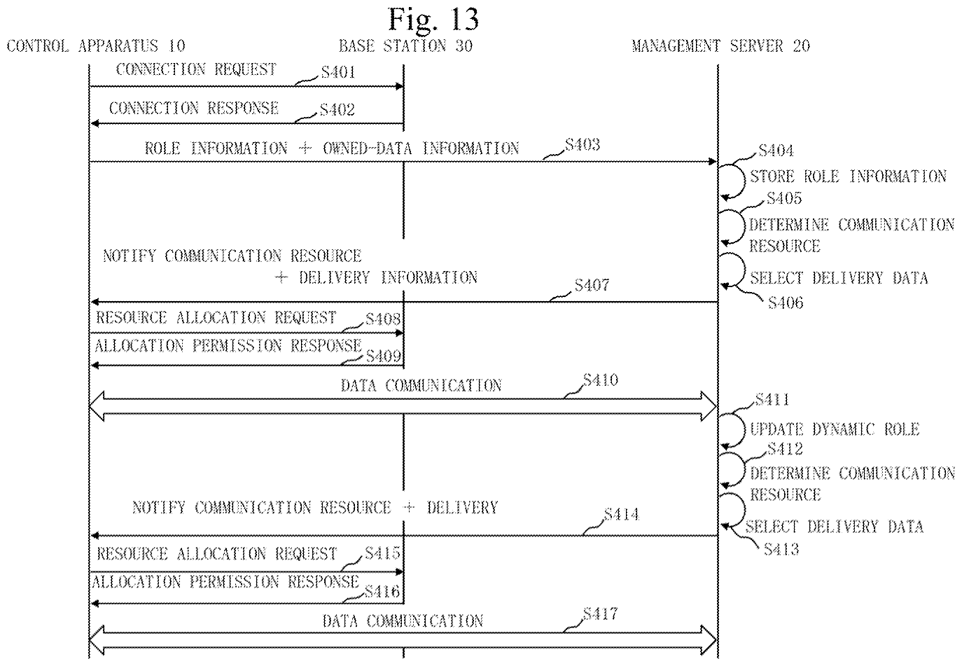

A resource allocation changing process according to Embodiment 2 will be described by referring to FIG. 13.

Processes from step S401 to step S410 are the same as the processes from step S101 to step S110 of FIG. 8. In the processes from step S401 to step S410, a role of the target object is specified based only on a static role.

In step S411, a dynamic role of the target object is specified. Then, the role management unit 212 of the management server 20 updates role information of the target object.

With regard to the dynamic role of the target object having been updated, the management server 20 may detect that the dynamic role of the target object has been updated, or the management server 20 may be notified by the control apparatus 10 that the dynamic role of the target object has been updated. For example, in the case of the vehicle traveling situation arising from the traffic situation, the management server 20 is able to detect the vehicle traveling situation arising from the traffic situation by updating the dynamic map. On the other hand, it is necessary for the control apparatus 10 to notify the management server 20 of whether or not the functions of the vehicle 100 are normal.

In step S412, the resource control unit 213 of the management server 20 determines a communication resource with regard to the control apparatus 10 installed on the target object according to the role that updated role information on the target object indicates. In step S413, the delivery data selection unit 214 of the management server 20 selects at least some pieces of management data among the management data as delivery data according to the communication resource determined in step S412.

In step S414, the data delivery unit 215 of the management server 20 transmits the communication resource and delivery information that indicates information included in the delivery data to the base station 30. The wired communication unit 313 of the base station 30 receives the communication resource and the delivery information. The wireless communication unit 311 of the base station 30 transmits the communication resource and the delivery information to the control apparatus 10.

Processes from step S415 to step S417 are the same as the processes from step S108 to step S110 of FIG. 8.

In a case where the dynamic role is updated again, the communication system 1 may make the process return to step S411.

In a case where the communication resource that the allocation request indicates cannot be allocated by the base station 30, the communication system 1 may perform processes that are the same as step S111 to step S114 of FIG. 9.

### Effect of Embodiment 2

As described above, in Embodiment 2, the communication system 1 specifies a role of the target object taking not only the static role but also the dynamic role into consideration. By the above, it will be possible to allocate an appropriate communication resource according to a change in a dynamic state. And, it will be possible to collect and deliver appropriate data according to the change in the dynamic state.

***Other Configurations***

<Variation 8>

The processes in Embodiment 2 illustrated in FIG. 13 may be changed as follows.

In step S411, the role management unit 212 of the management server 20 verifies whether or not it is better to determine a role of the target object based on the dynamic role after the update than on the static role. And then, in a case where it is better to determine the role of the target object based on the dynamic role after the update, the role management unit 212 will have the process proceed to step S412. On the other hand, in a case where the above is not so, the role management unit 212 will have the process proceed to step S417.

That is, in Embodiment 2, the role of the target object was specified based on both the static role and the dynamic role. On the contrary, in Variation 8, the role of the target object is specified based on the static role as a general rule, and only in a case where it is better to determine the role of the target object based on the dynamic role after the update, the role of the target object is specified based on the dynamic role.

For example, in a case where the position in the platoon changed because of a change in an order in the platoon or a change in a length of the platoon in the platooning vehicles, information that the vehicle 100 necessitates changes. In a case where there is a change in the vehicle traveling situation arising from the traffic situation and vehicle speed is reduced or the vehicles are stopped because of traffic congestion, reducing frequency of collection and delivery of data compared with when traveling at high speed can be considered. In a case where a state that is normal in which usual functions of the vehicle 100 are operating changes to a state that is abnormal in which the usual functions are not operating due to a breakdown or an accident, notifying about the abnormal state and the like of the vehicle 100 preferentially as emergency information is necessary. In such a case, allocation of the communication resource is reconsidered taking the above points into consideration.

On the other hand, in a case where the role has changed but the information that the vehicle 100 necessitates does not change, reconsidering the allocation of the communication resource is not necessary. In this case, the process proceeds to step S417 from step S411.

### Embodiment 3

Embodiment 3 differs from Embodiment 1 in that an allocation request of a resource is transmitted to the base station 30 from the management server 20. In Embodiment 3, this differing point will be described, and description will be omitted for points that are the same.

In Embodiment 1, an exchange of messages was done only between the control apparatus 10 and the management server 20, and between the control apparatus 10 and the base station 30. In Embodiment 3, the exchange of messages is also performed between the management server 20 and the base station 30.

In a case where an addition of an interface is necessary in at least either one of the management server 20 and the base station 30 to perform the exchange of messages between the management server 20 and the base station 30, the interface that is necessary is added.

In Embodiment 3, the base station 30 receives the allocation request of the resource from the management server 20. Consequently, the wired communication unit 313 and not the wireless communication unit 311 includes the request receiving unit 314.

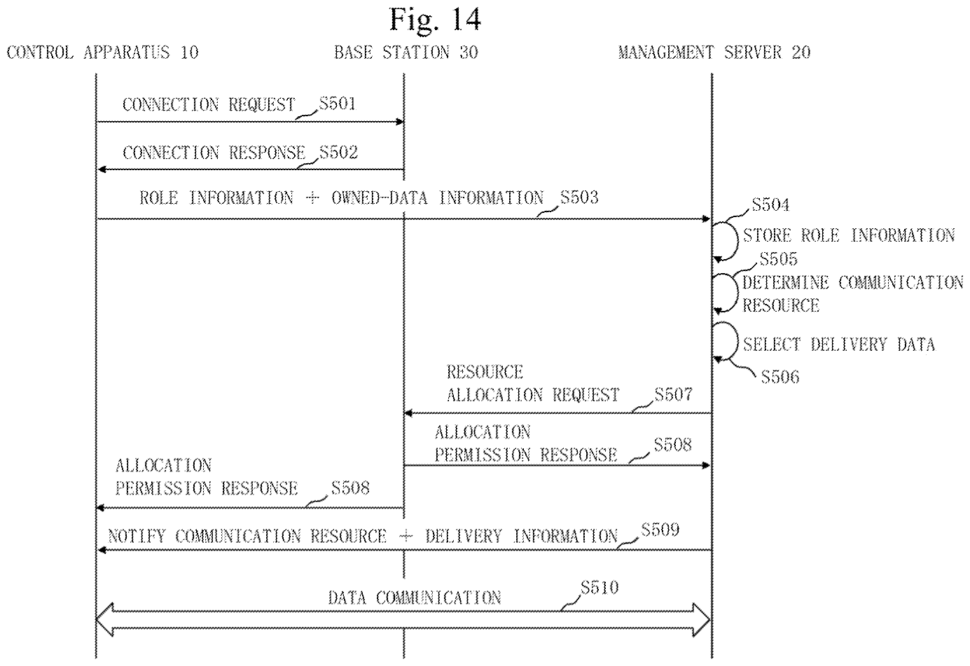

Processes up until a start of data communication in a communication system 1 according to Embodiment 3 will be described by referring to FIG. 14.

Processes from step S501 to step S506 are the same as the processes from step S101 to step S106 of FIG. 8.

In step S507, the data delivery unit 215 of the management server 20 transmits an allocation request of a resource indicating a communication resource to the base station 30. In step S508, the wired communication unit 313 (request receiving unit 314) of the base station 30 receives the allocation request of the resource transmitted in step S507. Then, the resource allocation unit 312 of the base station 30 allocates the communication resource that the allocation request indicates to the control apparatus 10 installed on the target object. And then, the wired communication unit 313 of the base station 30 transmits to the management server 20, an allocation permission response that indicates that the resource is allocated. The wireless communication unit 311 of the base station 30 transmits to the control apparatus 10, an allocation permission response that indicates that the resource is allocated.

In step S509, the data delivery unit 215 of the management server 20 transmits to the base station 30, the communication resource and delivery information indicating the information included in the delivery data. The wired communication unit 313 of the base station 30 receives the communication resource and the delivery information. The wireless communication unit 311 of the base station 30 transmits the communication resource and the delivery information to the control apparatus 10.

In step S510, the control information receiving unit 113 of the control apparatus 10 receives the communication resource and the delivery information transmitted in step S509. And then, the control apparatus 10 carries out data communication with the base station 30 using the communication resource that has been allocated.

In a case where the communication resource that the allocation request indicates cannot be allocated by the base station 30, the communication system 1 may return the process to step S505, and may determine again a communication resource with regard to the control apparatus 10 installed on the target object.

### Effect of Embodiment 3

As described above, the communication system 1 according to Embodiment 3 transmits the allocation request of the resource to the base station 30 from the management server 20. By the above, transmitting the allocation request of the resource to the base station 30 from the control apparatus 10 will not be necessary.

As a result, in a case where the communication resource that the allocation request indicates cannot be allocated by the base station 30, the management server 20 may determine again a communication resource, and the management server 20 may transmit again the allocation request of the resource to the base station 30 without a message being transmitted to the management server 20 from the control apparatus 10. Consequently, a communication amount in the communication system 1 as a whole can be reduced.

### Embodiment 4

Embodiment 4 differs from Embodiment 1 in that a base station 30 determines a communication resource to be allocated to the target object and delivery data to be delivered to the target object. In Embodiment 4, this differing point will be described, and description will be omitted for points that are the same.

In Embodiment 1, the allocation of the communication resource was performed by the base station 30 after the management server 20 determined the communication resource and the delivery data. In Embodiment 4, the base station 30 determines the communication resource and the delivery data and performs the allocation of the communication resource.

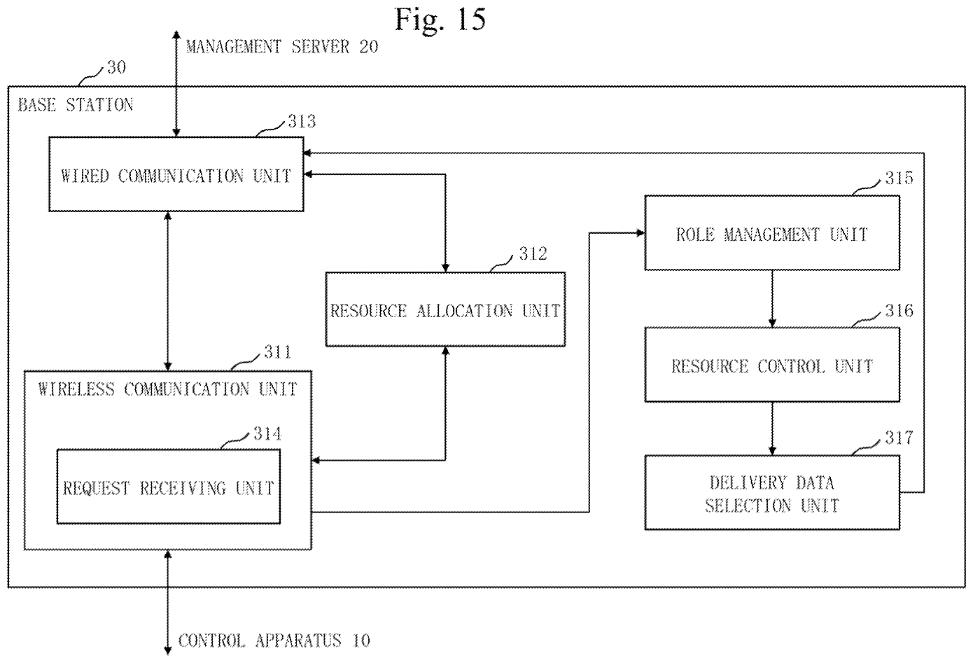

A functional configuration of the base station 30 according to Embodiment 4 will be described by referring to FIG. 15.

The base station 30 including, as functional components, a role management unit 315, a resource control unit 316, and a delivery data selection unit 317, is what differs from the base station 30 illustrated in FIG. 6.

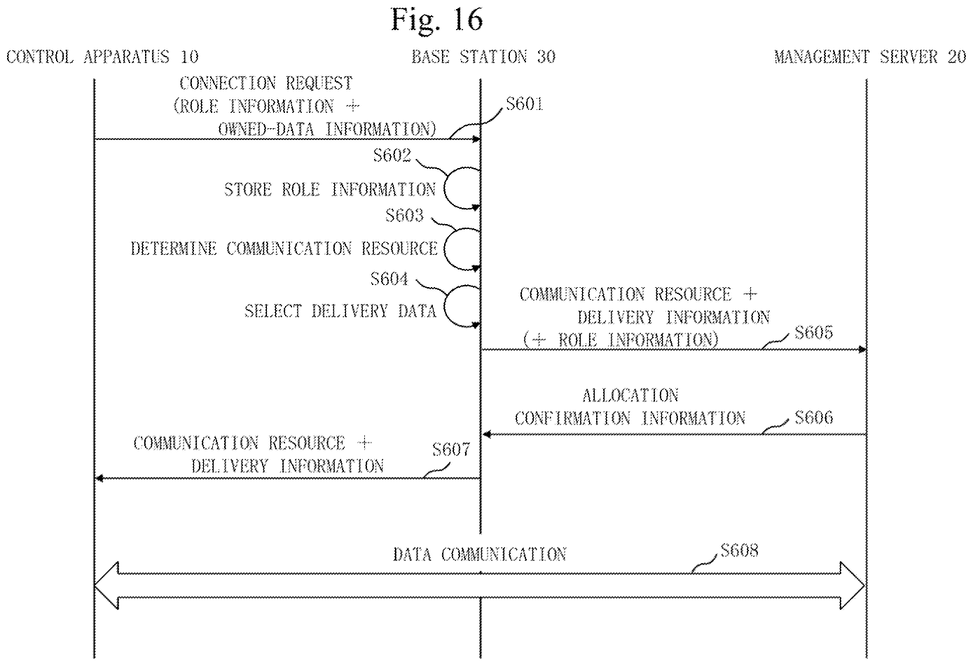

Processes up until a start of data communication in a communication system 1 according to Embodiment 4 will be described by referring to FIG. 16.

In step S601, the control information transmission unit 112 of the control apparatus 10 transmits a connection request to the base station 30. At this time, the control information transmission unit 112 transmits role information and owned-data information along with the connection request.

For example, a message of the connection request is made to have a field for inserting the role information and the owned-data information. And then, the control information transmission unit 112 transmits to the base station 30, the connection request after inserting the role information and the owned-data information to the connection request.

In step S602, the wireless communication unit 311 of the base station 30 receives the connection request accompanied by the role information and the owned-data information. Then, the role management unit 315 of the base station 30 stores the role information. In step S603, the resource control unit 316 of the base station 30 determines the communication resource with regard to the control apparatus 10 installed on the target object according to the role that the role information on the target object indicates. In step S604, the delivery data selection unit 317 of the base station 30 selects at least some pieces of management data among the management data as delivery data according to the communication resource determined in step S605. In step S605, the wired communication unit 313 of the base station 30 transmits the communication resource and delivery information to the management server 20. At this time, the wired communication unit 313 may also transmit the role information. In step S606, the control information receiving unit 211 of the management server 20 receives the communication resource and the delivery information. Then, the data delivery unit 215 transmits allocation confirmation information to the base station 30.

In step S607, the wired communication unit 313 of the base station 30 receives the allocation confirmation information. Then, the wireless communication unit 311 of the base station 30 transmits the communication resource and the delivery information to the control apparatus 10.

In step S608, the control information receiving unit 113 of the control apparatus 10 receives the communication resource and the delivery information. And then, the control apparatus 10 carries out data communication with the base station 30 using the communication resource that has been allocated.

### Effect of Embodiment 4

As described above, in the communication system 1 according to Embodiment 4, the base station 30 determines a communication resource and delivery information. By the above, a communication procedure in the communication system 1 as a whole will be simplified.

The embodiments and the variations of the present disclosure have been described above. Some of the embodiments and the variations among these embodiments and the variations may be combined and executed. One or some of the embodiments and the variations may partially be executed. The present disclosure is not to limit to the above embodiments and variations, and various changes are possible as necessary.

### REFERENCE SIGNS LIST

1: communication system; 10: control apparatus; 111: role setting unit; 112: control information transmission unit; 113: control information receiving unit; 114: sensing unit; 115: probe data generation unit; 116: transmission data selection unit; 117: data transmission unit; 118: data receiving unit; 119: driving control unit; 120: perception unit; 121: conclusion unit; 122: control unit; 131: CPU; 132: ROM; 133: RAM; 134: external storage device; 135: wireless communication device; 20: management server; 211: control information receiving unit; 212: role management unit; 213: resource control unit; 214: delivery data selection unit; 215: data delivery unit; 216: data collection unit; 217: map management unit; 231: CPU; 232: ROM; 233: RAM; 234: external storage device; 235: wired communication device; 30: base station; 311: wireless communication unit; 312: resource allocation unit; 313: wired communication unit; 314: request receiving unit; 315: role management unit; 316: resource control unit; 317: delivery data selection unit; 331: CPU; 332: ROM; 333: RAM; 334: external storage device; 335: wireless communication device; 336: wired communication device; 91: wireless network; 92: wired network.

1. A control apparatus to be installed on a mobile object that is a vehicle comprising:
processing circuitry to:
generate probe data from sensing data obtained by sensing objects in the mobile object's surroundings,
select at least some pieces of probe data as transmission data from the probe data generated, according to a communication resource determined according to a role of the mobile object that is set according to at least any one of a position of the mobile object in a platoon configured of a plurality of vehicles, whether or not the mobile object is an emergency vehicle, whether or not the mobile object is a remote control vehicle that is remotely operated, and whether or not the mobile object is a vehicle of public transportation, and
transmit the transmission data selected to a management server.

2. The control apparatus according to claim 1, wherein the management server manages management data, wherein
the processing circuitry
receives from the management server as delivery data, at least some pieces of management data selected among the management data according to the communication resource.

3. The control apparatus according to claim 1, wherein
the role is specified based on at least either one of a static role that is specified regardless of a moving state of the mobile object and a dynamic role that changes according to the moving state of the mobile object.

4. A mobile object on which the control apparatus according to claim 1 is installed.

5. A management server that manages management data comprising:
processing circuitry to:
receive from a control apparatus installed on a mobile object that is a vehicle, role information that indicates a role of the mobile object that is set according to at least any one of a position of the mobile object in a platoon configured of a plurality of vehicles, whether or not the mobile object is an emergency vehicle, whether or not the mobile object is a remote control vehicle that is remotely operated, and whether or not the mobile object is a vehicle of public transportation,
determine a communication resource according to the role that the role information received indicates,
select at least some pieces of management data among the management data as delivery data according to the communication resource determined, and
deliver the delivery data selected to the control apparatus.

6. The management server according to claim 5, wherein
the processing circuitry
receives as the role information, static role information that indicates a static role that is specified regardless of a moving state of the mobile object and dynamic role information that indicates a dynamic role that changes according to the moving state of the mobile object, and
determines a communication resource according to the role specified based on at least either one of the static role information and the dynamic role information.

7. A base station that relays communication between a control apparatus installed on a mobile object that is a vehicle and a management server that manages management data comprising:
processing circuitry to:
receive an allocation request of a resource for the control apparatus and the management server to perform communication, and
allocate, to communication with the mobile object, a communication resource determined according to a role of the mobile object that is set according to at least any one of a position of the mobile object in a platoon configured of a plurality of vehicles, whether or not the mobile object is an emergency vehicle, whether or not the mobile object is a remote control vehicle that is remotely operated, and whether or not the mobile object is a vehicle of public transportation, when the allocation request is received.

8. The base station according to claim 7, wherein
the processing circuitry
allocates, to the communication with the mobile object, the communication resource based on resource information that indicates the communication resource determined according to the role of the mobile object by the management server.

9. The base station according to claim 7, wherein
the processing circuitry
receives from the control apparatus installed on the mobile object, role information that indicates the role of the mobile object,
determines a communication resource according to the role that the role information received indicates, and
allocates, to the communication with the mobile object, the communication resource determined.

10. The base station according to claim 9, wherein
the processing circuitry
receives as the role information, static role information that indicates a static role that is specified regardless of a moving state of the mobile object and dynamic role information that indicates a dynamic role that changes according to the moving state of the mobile object, and
determines a communication resource according to the role specified based on at least either one of the static role information and the dynamic role information.

11. The base station according to claim 7, wherein
the processing circuitry
receives the allocation request from the management server that determined the communication resource according to the role of the mobile object.

12. A communication system comprising:
a control apparatus to be installed on a mobile object that is a mobile object that is a vehicle;
a management server to manage management data; and
a base station to relay communication between the control apparatus and the management server, wherein
the control apparatus transmits to the management server, role information that indicates a role of the mobile object that is set according to at least any one of a position of the mobile object in a platoon configured of a plurality of vehicles, whether or not the mobile object is an emergency vehicle, whether or not the mobile object is a remote control vehicle that is remotely operated, and whether or not the mobile object is a vehicle of public transportation,
the management server determines a communication resource according to the role that the role information transmitted indicates,
the base station allocates, to communication with the mobile object, the communication resource determined, and
the control apparatus
selects at least some pieces of probe data as transmission data from probe data obtained by sensing the mobile object's surroundings, according to the communication resource, and
transmits the transmission data selected to the management server through the base station.

13. A communication method performed by a control apparatus to be installed on a mobile object that is a vehicle, a management server that manages management data, and a base station that relays communication between the control apparatus and the management server, the communication method comprising:
transmitting to the management server, role information that indicates a role of the mobile object that is set according to at least any one of a position of the mobile object in a platoon configured of a plurality of vehicles, whether or not the mobile object is an emergency vehicle, whether or not the mobile object is a remote control vehicle that is remotely operated, and whether or not the mobile object is a vehicle of public transportation, by the control apparatus;
determining a communication resource according to the role that the role information indicates, by the management server;
allocating, to communication with the mobile object, the communication resource, by the base station;
selecting at least some pieces of probe data as transmission data from probe data obtained by sensing the mobile object's surroundings, according to the communication resource, by the control apparatus; and
transmitting the transmission data to the management server through the base station, by the control apparatus.
